(19) United States
(12) Patent Application Publication
(10) Pub. No.: US 2025/0376612 A1
(43) Pub. Date: Dec. 11, 2025

(54) PLA DISPERSION AS FILTRATION CONTROL AGENT IN DRILLING FLUIDS

(71) Applicant: LyondellBasell Advanced Polymers Inc., Houston, TX (US)

(72) Inventors: Bradley L. Todd, Duncan, OK (US); Kristie Ince, Duncan, OK (US)

(73) Assignee: LyondellBasell Advanced Polymers Inc., Houston, TX (US)

(21) Appl. No.: 19/229,635

(22) Filed: Jun. 5, 2025

Related U.S. Application Data
(60) Provisional application No. 63/656,955, filed on Jun. 6, 2024.

(51) Int. Cl. C09K 8/08; E21B 7/18

(52) U.S. Cl. CPC C09K 8/08; E21B 7/18

(57) ABSTRACT

A well fluid containing submicron polylactic acid (PLA) particle dispersions for use as a filtration control agent have applicability in low temperature reservoirs and are easy to clean-up after treatment. Methods for the application of PLA containing drilling, completion or drill-in fluids are also discussed.

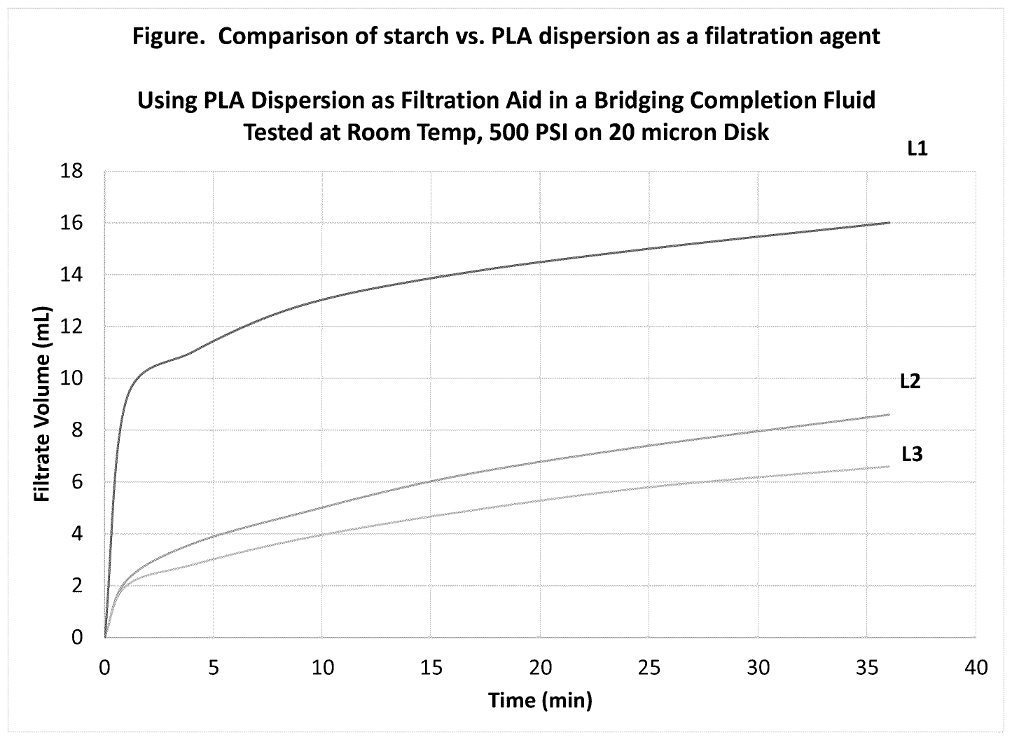

### PRIOR RELATED APPLICATIONS

This application claims the benefit of priority to U.S. Provisional Application No. 63/656,955, filed on Jun. 6, 2024, which is incorporated here by reference in its entirety.

FEDERALLY SPONSORED RESEARCH STATEMENT Not applicable.

### FIELD OF THE DISCLOSURE

The disclosure generally relates to compositions of drilling fluids with polylactic acid (PLA) as a filtration control agent, which can be used in lower temperature reservoirs and still clean up well.

### BACKGROUND OF THE DISCLOSURE

During oil and gas drilling, drilling fluids are circulated down the wellbore to cool and lubricate the bit, control fluid losses, and protect the reservoir from solids incursion by forming a filter cake on the walls of the well, suspend and move rock cuttings to the surface, and to control pressure. A typical water-based drilling fluid is made with brine and bentonite to form an aqueous viscous carrier fluid to carry rock chips to the surface, a bridging agent to bridge across fractures and pores in the formation thus forming a filter cake. Also added is a filtration control agent to further reduce permeability of the filter cake. Since drilling fluid must provide sufficient hydrostatic pressure to prevent formation fluid from entering the wellbore during drilling, solid weighting agents (such as barite or calcium carbonate) are also typically added to the brine mixture to increase its density. Smaller quantities of other chemicals including corrosion inhibitors, pH control agents, lubricants, stabilizers, scale inhibitors, friction reducers etc. may also added to the drilling fluid.

In use, the drilling fluid is pumped down a hollow drill pipe to the drill bit, and then is flushed back up the borehole annulus to the surface carrying the rock cuttings formed by the bit. The bridging and filtration control agents deposit on the well walls, thus forming a thin layer of solid called the “filter cake.” Generally, the filter cake coats the borehole wall preventing the drilling fluid and/or weighting agent from significantly entering the formation and causing formation damage. Filter cakes can also block any thief zones, thus preventing loss of drilling fluid into the thief zone.

Typically, starch is added to drilling fluids as the filtration control agent, but starch also contributes to viscosity as it is soluble in water. Starch is readily available, performs well over a wide range of pH, does not cause formation damage, and has applicability in a wide range of salinity. Because of its abundance, stability, and inherent environmental friendliness, it is used as fluid loss control agent for all types of mud-based drilling systems and is particularly useful in salt water-based systems.

During the completion stage, however, filter cake must be removed. Indeed, in any application, removal of the filter cake is typically needed once the operation is complete and inefficient removal creates difficulties for subsequent operations, including production. For example, at completion, the thin layer of filter cake can restrict the flow of hydrocarbons into the well and cause an additional pressure drop that ultimately can reduce the productivity of the well.

The removal of starch is usually done with chemicals or enzymes. In some applications starch is degraded by adding enzymes like amylase that hydrolyze the glycosidic bonds in starch. Amylases are able to act in a wide pH range (2-12) and some of them have a good thermostability, being an advantage for industrial processes.

While useful in solution, enzymatic removal is far less effective in reservoir applications, likely due to the harsh local environment adversely affecting enzyme activity. Thus, specialized fluids have been developed to break up starch-based filter cake. Both mechanical (water jetting) and chemical means (acids, oxidizers, chelating agents, and enzymes) have been used in the field. However, these methods have limitations which can adversely affect well performance.

Thus, what is needed in the art is a non-starch based filtration control agent for use in drilling fluids that can be used at low temperatures and is easier to remove after use, preferably not leaving any harmful residue in the formation. The ideal composition would also be economical, easy to formulate, non-toxic, non-damaging, and have high efficiency in terms of filtration numbers and properties. This invention addresses one or more of these needs.

### SUMMARY OF THE DISCLOSURE

Described herein are compositions and applications of drilling, drill-in, completion and other reservoir fluids containing one or more bridging agents plus a polylactic acid (PLA) particle dispersion as filtration control agent. The PLA dispersion filtration control agent forms impermeable, thin and tough filter cake in the formation, but the filter cake is easily and completely removed with the use of mild acids, even in low temperature reservoirs (=about 80° C. (176° F.)).

The composition described herein is also compatible with high salinity brines, and common carrier fluids, bridging particles and other chemicals used in drilling fluids, drill-in fluids, completion fluids and stimulation fluids. Additional components may be added to the fluid loss control compositions as needed for the application. For example, a drilling fluid will have brine, weighting agents, and a viscosity increasing agent such as xanthan gum and/or bentonite clay, but clay and weighting agents are omitted from drill-in or completion fluids.

Poly(lactic) acid (PLA) is biodegradable polymer usually derived from renewable plant sources such as corn starch, sugar beet, or sugar cane, with the formula (C₃H₄)₂)ₙ or —[CH(CH₃)COO—]ₙ—. It is primarily produced by industrial polycondensation of D or L lactic acid and/or ring opening polymerization (ROP) of the lactide, shown below in Equation 1.

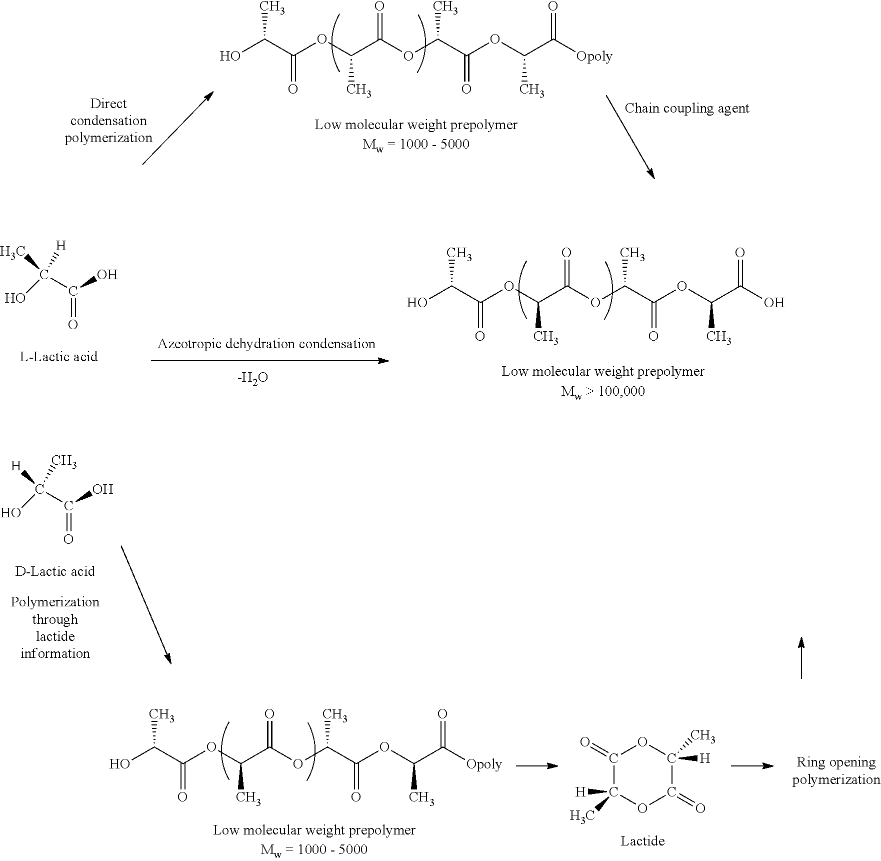

The physical properties of PLA vary based on the starting raw materials and processing grade, but it has similar physical characteristics to petrochemical plastics like polypropylene (PP), polyethylene (PE), or polystyrene. PLA is soluble in many common hydrocarbon solvents including benzene, dioxane, THF, but is largely insoluble in water. PLA can last for more than a year at ambient surface temperatures, but degrades by slow hydrolysis, with higher temperatures increasing the degradation rate.

Due to the chiral nature of lactic acid, distinct forms of poly(lactide) may be produced with differing characteristics. Poly-L-lactide (PLLA) results from polymerization of L,L-lactide (also known as L-lactide). D-lactide forms poly-D-lactide (PDLA) and a racemic mixture of L- and D-lactides usually leads to the synthesis of poly-DL-lactide (PDLLA), which is amorphous. PLA polymers thus range from amorphous glassy polymer to semi-crystalline and highly crystalline polymer with a glass transition temperature of 60-65° C. (140-149° F.), a melting temperature of 130-180° C. (266-356° F.), and a Young's modulus of 2.7-16 GPa. Heat-resistant PLA can withstand temperatures of up to 110° C. (230° F.).

The melting temperature of PLLA can be increased by 40-50° C. (104-122° F.) and its heat deflection temperature (temperature at which a polymer or plastic sample deforms under a specified load) can be increased from approximately 60° C. (140° F.) to up to 190° C. (374° F.) by physically blending the PLLA polymer with PDLA.

Optical lactic acid can be produced by certain species of bacteria. For example, the genus Lactobacillus produces D, L, and racemic mixtures, genus Pediococcus produces either pure L or some strains produce a racemic mixture, Leuconostoc and Oenococcus are producers of D-isomer, and genus Weissella produces either D-isomer or racemic mixture. The polylactic polymers in the current market, by contrast, are typically prepared from a less expensive racemic mixture of the D- and L-lactic acids, and it can be chemically named poly-DL-lactide.

In one embodiment described herein, the drilling fluid contains aqueous xanthum gum and/or bentonite clay as a viscosity increasing agent, calcium carbonate particles as a bridging agent, and a PLA dispersion in water as a filtration control agent. The PLA dispersion and calcium carbonate form an impermeable PLA-filter cake to block pores and stop whole fluid invasion in the formation. Removal of the filter cake is accomplished by injection of a mild organic acid like acetic acid that hydrolyzes the PLA under low temperature reservoir conditions. The hydrolyzed PLA is then pumped out along with the flow back fluids, and operations may continue. Solids laden drill-in and completions fluids are similar, but typically omits the weighting agent and clay.

There are many common methods of preparing PLA dispersions. If needed, the PLA is ground or otherwise reduced in size and sieved to obtain the correct size particles. PLA of the correct size dispersion is then prepared by mixing the particles with an organic solvent, like ethyl acetate, with a water phase containing a surface-active dispersing agent, followed by homogenizing the mixture, usually by high shear mixing. Coating the particles with organic solvent and the dispersing agent prevents the insoluble particles from agglomerating. However, any other known or to be developed methods for dispersing water insoluble polymers may be used for the preparation of a PLA dispersion.

The average size of the PLA dispersion may vary, depending on the fracture properties of the reservoir, larger fractures and pores allowing larger particles. However, typically the PLA dispersion will include particles between 0.1 and 5 microns in diameter, or 1-3 microns in diameter, or less than 1 micron. In certain embodiments, the PLA dispersion includes particles at both the upper and lower range specified above, wherein the larger diameter particles are suitable for filling spaces created by larger bridging particles and the smaller diameter particles able to plug the remaining pore throats to achieve the desired level of filtration control. As used herein, pore throat refers to a small pore space in particulate pack where two or more grains meet, which connects two larger pore volumes.

Molecular weight for PLA of about 20,000-50,000 g/mol are common. In some embodiments, 25,000-40,000 g/mol, or 30,000-45,000 g/mol PLA may also be used. A 30,000 g/mol PLA may be preferred. In other embodiments, a high MWT polymer of 80,000 up to 250,000 g/mol may be used.

The inventive fluids may also include other additives as needed for the application, such as salts, pH control additives, surfactants, breakers, biocides, crosslinkers, additional fluid loss control agents, stabilizers, chelating agents, scale inhibitors, gases, mutual solvents, particulates, corrosion inhibitors, oxidizers, reducers, friction reducers, drilling lubricants, acid precursors, enzymes, clay stabilizers, and any combination thereof.

To measure the effectiveness of the PLA as a filtration control agent, filter cakes were produced with a fluid containing xanthum gum as the viscosity agent, calcium carbonate as the bridging agent and PLA as the filtration control agent. The filtration properties of the filter cake were measured using an American Petroleum Institute (API) filter press. Filter cake of adequate thickness was first produced, and fluid loss through the filter cake measured. We used a modified API RP 13B-1 protocol for our filter tests, but ISO 10414-1:2008 could also be used, in addition to more sophisticated methods such as NMR, SEM, CT scan or XRF. Once the level of impermeability is determined, clean-up can be assessed as described herein.

Filter cake formed with PLA dispersion as filter aid can be easily removed by washing with suitable fluids containing mild acids, such as acetic acid (CH₃COOH) at a concentration of about 5-25 vol. %. In some embodiments, 8-20 vol. %, or 10-15 vol. % may also be used. A 10% acetic acid solution in fresh water may be preferred. A solution of acetic acid in a corrosion inhibitor, surfactant, mutual solvent or an iron control agent, or combinations thereof may also be used.

In general, the use of PLA dispersions comprising submicron particles as a filtration control agent provides low filtration numbers, applicability in a variety of low to medium temperature reservoirs and allows easy clean-up with mild treatment methods. Further, it can also be used in higher temperature reservoirs if care is taken to select a PLA with a higher melt and/or deformation temperature. One of ordinary skill in the art will be able to decide and recognize various combination of reagents and chemicals that need to be added to the drilling fluid for desired filter cake property.

The invention includes any one or more of the following embodiments, in any combination(s) thereof.

A drilling fluid for drilling a well in a hydrocarbon reservoir comprising: i) an aqueous carrier fluid or brine, ii) a viscosity increasing agent selected from a clay or a polymer or a polysaccharide, iii) a solid particle bridging agent, and iv) a solid particle poly(lactic acid) (PLA) filtration control agent. The fluid may also be a solids laden completion or drill in fluid, which typically omits the weighting agent and clay.

Any fluid herein described, wherein said PLA is in the form of solid particles having a diameter of between 0.1 to 5 microns dispersed in said aqueous carrier fluid.

Any fluid herein described, where the PLA is dispersed by mixing first with an organic solvent, then with an aqueous solution containing a dispersion agent and homogenizing or otherwise vigorously mixing the solution. If needed, the PLA can be ground or otherwise comminuted, and size sieved to obtain a suitable size range for its sealant purposes. Preferably, the PLA comprises submicron particles having a diameter of about 0.1 to 1.0 micron. When we refer to size herein, we mean an average size.

Any fluid herein described, wherein said PLA is poly-L-lactide (PLLA), poly-D-lactide (PLLA) or poly-DL-lactide (PDLLA), or a blend of PLLA and PDLA. Preferred the PLA is made from a racemic mixture of D and L forms (PDLLA).

Any fluid herein described, wherein said PLA is a 1:1 blend of PLLA and PDLA.

Any fluid herein described, wherein concentration of said PLA is about 1-50 lbs/bbl or about 5-20 or about 7-10 lbs/bbl.

Any fluid herein described, wherein said viscosity agent is one or more selected from the group consisting of cellulose, guar gum, carboxymethylcellulose, xanthum gum, modified xanthum or guar gum derivatives selected from a group consisting of xanthum or guar gum grafted with acrylic acid, acrylamide, and 2-acrylamido-2-methylpropane sulfonic acid (AMPS). For drilling fluids, the viscosity agent may also be clay or bentonite and the like.

Any fluid herein described, wherein said viscosity agent is a xanthum gum at 0.10 to 50 lbs/bbl, or preferably 0.50-20 lbs/bbl or about 0.7-5 lbs/bbl.

Any fluid herein described, wherein said bridging agent is one or more selected from the group consisting of calcium carbonate, magnesium oxide, suspended salt (water-soluble) and oil-soluble resins.

Any fluid herein described, wherein said bridging agent is calcium carbonate at about 10-50 lbs/bbl, or preferably about 15-30 lbs/bbl or most preferred about 20 lbs/bbl.

Any fluid herein described, wherein the weighting agent (when used) is selected from one or more of the group consisting of barite, calcium carbonite, siderite, micromax, ilmenite, and hematite particles.

Any fluid herein described, comprising one or more additives selected from the group consisting of salts, pH control additives, surfactants, breakers, biocides, crosslinkers, additional fluid loss control agents, stabilizers, chelating agents, scale inhibitors, gases, mutual solvents, particulates, corrosion inhibitors, oxidizers, reducers, friction reducers, drilling lubricants, acid precursors, enzymes, clay stabilizers, and combinations thereof.

A method of drilling in a hydrocarbon formation, said method comprising: drilling a borehole in a hydrocarbon formation using any drilling fluid herein described to form a filter cake on a wall of said borehole, continuing until drilling is complete, and removing said filter cake with a cleaning fluid comprising a weak acid.

A method of drilling through a play in a hydrocarbon formation, said method comprising: drilling a borehole in a play hydrocarbon formation using any drill-in fluid herein described to form a filter cake on a wall of said borehole, continuing until drilling through said play is complete, and removing said filter cake with a cleaning fluid comprising a weak acid.

A method of completing a well in a hydrocarbon formation, said method comprising: forming a filter cake in a well using any completion fluid herein described, completing said well, and thereafter removing said filter cake with a cleaning fluid comprising a weak acid.

Any method herein described, wherein said weak acid is acetic acid, preferably about 1-25% or 5-20% or about 10% acetic acid.

Any method herein described, wherein said PLA is made from a racemic mix of D and L lactic acid and said reservoir is at a temperature of 150-190° C. (300-375° F.).

Any method herein described, wherein said reservoir is at a temperature of <100° C. (<212° F.).

As used herein, a “fluid-loss control fluid” is a fluid that contains at a minimum a bridging agent and a filtration control agent, with various other ingredients added depending on the specific reservoir application in which the fluid-loss control fluid will be used.

As used herein “drilling fluid” or “drilling mud” is a high viscosity, high density liquid that aids in the process of drilling a borehole into the earth for the production of oil and gas. The drilling fluid lubricates the wellbore, cools the drill bit, carries away rock cuttings, and provides sufficient hydrostatic pressure to prevent oil from seeping into the well during drilling. The composition of drilling fluid include the carrier fluid, one or more viscosity agents (such as gums), bridging agents. fluid loss control agents, and weighting agents.

As used herein, a “drill-in fluid” or “reservoir drill in fluid” (RDF) refers to a type of drilling fluid designed especially for drilling through the reservoir section of a wellbore. The drill-in fluid is packaged to cause minimum damage to the formation while maximizing recovery of hydrocarbon. The composition of drill in fluid closely resemble completion fluid but differs from drilling fluid in that it is made up of acid soluble or water soluble bridging agents, no clays or no other weighting agents are used. Starch is not acid soluble at all temperatures where a drill-in fluid or completion fluid would be used at, hence the need for a replacement for starch.

As used herein, a “completion fluid” is used to ‘complete’ an oil and gas well. Completion fluids improve well productivity by reducing damage to the producing zones and complete the wellbore during the completion phase. These are typically brines and may contain small amounts of other chemicals useful to successfully complete a well. The “completion fluid” used in the present disclosure are solids laden fluids, containing viscosity agents, bridging agents and filtration control agents, but no clay or weighting agents.

As used herein, a “carrier fluid” refers to a fluid used to transport materials into and out of a wellbore. The carrier fluid is chosen for its ability to efficiently transport chemicals or solids required for drilling, hydraulic fracturing, acid treatment, sweeps, stimulations, and the like, its ability to separate and release materials as the application requires, and its compatibility with other wellbore fluids and the reservoir so as to not cause any formation damage. Water, water with salts, water with oil-based mud, water with polymers or polysaccharides, water with varying amounts of organic solvents like glycol, kerosene, etc. are usually used as carrier fluids, although for some applications the carrier is oil-based.

As used herein a “brine” is a water plus salt solution. Typical oil field brines contain dissolved chlorides, bromides, bicarbonates and/or formats of sodium, calcium, magnesium, potassium, cesium etc.

As used herein a “viscosity agent” is a chemical added to a carrier fluid whose primary purpose is to increase its viscosity so as to carry, e.g., rock cuttings or proppant. Viscosity agents include one or more of muds, clays, bentonite clay, various polysaccharides, such as guar gum and xantham gum, starch, cellulose, carboxymethylcellulose, Kian (Averrhoa carambola L), Achi (Brachystegia nigerica), Offor (Detarium microcarpum), scleroglucan, gum derivatives selected from a group consisting of a gum grafted with acrylic acid, acrylamide, and 2-acrylamido-2-methylpropane sulfonic acid (AMPS), and polymers such as acrylamide based polymers and copolymers.

As used herein a “bridging agent” or “bridging material” is a solid material added to a completion fluid whose primary function is to block the pore throat or fractures of an exposed rock, thereby building a filter cake to prevent loss of whole mud or excessive filtrate. For reservoir applications, the bridging agent should be removable and common bridging materials include calcium carbonate (acid-soluble), magnesium oxide, suspended salt (water-soluble) or oil-soluble resins. Any solid that can be dissolved by a mild acid or naturally degradable over time, for example, urea-formaldehyde resins and isobutylidenediurea (IBDU) polyphosphates.

One preferred bridging agent is calcium carbonate. Calcium carbonate is typically commercially available in three grind sizes-fine, medium and coarse. The application of fine, medium, and coarse particle sizes is dependent on the type of formation. For example, if the formation is highly permeable, medium, or coarse grind sizes are used. Calcium carbonate as bridging agent has many advantages including its minimum effect on fluid properties, effective bridging properties and being largely inert and insoluble.

As used herein “filtration control agent” is a solid material added to the drilling or other fluid whose primary purpose is to decrease the permeability of a filter cake that contains bridging agent. Common filtration control agents include starch or cellulose, but herein we used dispersed PLA particles.

As used herein ‘filter cake’ is a thin, relatively impermeable solid mass comprising mainly bridging and filtration control agents. It deposits onto porous permeable formations as fluid penetrates the formation, preventing further fluid ingress. The formation of the relatively impermeable filter cakes stabilizes the wellbore and helps in fluid loss control.

As used herein a “weak acid” is an acid that does not completely dissociate into its ions in water (and excluding HF). Thus, weak acids include formic acid and acetic acid. Acetic acid is preferred.

In addition to ordinary weak acids, other filter cake breaking systems could be used herein. For example, the N-FLOW™ 325 filter cake breaker from Halliburton® is a delayed acid generator that allows the slow release of acid. When spotted downhole N-FLOW 325 breaker reacts with water, generates acid, and subsequently dissolves the calcium carbonate and PLA in the filter cake, thereby removing the cake. N-FLOW breaker products can be placed across the entire interval before acid is generated, improving overall clean-up. N-FLOW 325 breaker is suitable for use in most brines at temperatures from 25-95° C. (75-205° F.) to give break times of up to 16 hours. Other filter cake breakers may be tested before use (as described below) to determine their applicability for a given drilling fluid/reservoir combination.

All concentrations used herein are in weight/volume percent (w/v %) or lbs/bbl unless otherwise specified. Particle size is described in US standard sieve mesh size, and microns.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements but allows the inclusions of non-material elements that do not substantially change the nature of the invention, such as instructions for use, buffers, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

TABLE 1
Abbreviations

| ABBREVIATION | TERM |
|---|---|
| AMPS | 2-acrylamido-2-methylpropane sulfonic acid |
| API | American Petroleum Institute |
| bbl | Barrel (42 US gallons, approximately 159 liters) |
| CT | Computed tomography |
| HF | Hydrofluoric acid |
| GPa | Gigapascal |
| lbs | Pounds |
| MW | Molecular Weight |
| NMR | Nuclear magnetic resonance |
| PE | Polyethylene |
| PGA | Polyglycolic acid |
| PLA | Polylactic acid |
| PLLA | Poly-L-lactic acid |
| PDLA | poly-D-lactic acid |
| PDLLA | poly-DL-lactic acid |
| PP | Polypropylene |
| RDF | Reservoir drill-in fluid |
| ROP | Ring opening polymerization |
| SEM | Scanning electron microscope |
| THF | Tetrahydrofuran |
| XRF | X-ray Fluorescence |

### BRIEF DESCRIPTION OF THE DRAWINGS

The FIGURE. Comparison of fluids containing starch versus a PLA dispersion as a filtration control agent.

### DETAILED DESCRIPTION

A static filter press test was conducted for comparing the filtration characteristics of a filter cake containing starch versus a PLA dispersion as the filtration control agent. For this proof-of-concept test, a completion fluid was used, but we predict that the test will prove applicable to complete mud-based drilling fluids as well.

The test was run using API filter press standard at room temperature and 500 psi differential pressure, using a 20-micron ceramic disk. The test apparatus was a standard filter press consisting of a cylindrical cell containing ˜350 mL of drilling fluid mounted on a frame. The test was run for about 30 minutes at 500 psi pressure. At the end of the test, filtrate volume was collected and measured.

The composition of the drilling fluid used for the test is shown in Table 2.

TABLE 2
Formulation of the fluid for API filtration stress test

| Component | L1 | | L2 | | L3 | |
|---|---|---|---|---|---|---|
| Brine | 6% NaCl (1M) | | 6% NaCl (1M) | | 6% NaCl (1M) | |
| Xanthum Gum (Prince | 0.7 | lbs/bbl | 0.7 | lbs/bbl | 0.7 | lbs/bbl |
| Energy LLC, PRIMO XAN D) | | | | | | |
| Fine Calcium Carbonate, | 20 | lbs/bbl | 20 | lbs/bbl | 20 | lbs/bbl |
| (North Mountain Supply, | | | | | | |
| Food Grade) | | | | | | |

| | | | | | |
|---|---|---|---|---|---|
| Starch | 7 | lbs/bbl (20 g/L) | 7 | lbs/bbl (20 g/L) | N/A |

| | | | |
|---|---|---|---|
| PLA (LyondellBasell) | N/A | NA | 5.7% v/v |

The FIGURE shows the result of the test. In this graph, L1 shows filtration through a filter cake made from a fluid containing starch as the filtration control agent. L2 and L3 present filtration through a filter cake made with a similar fluid but substituting a PLA dispersion as the filtration control agent.

In all cases, the initial steep increase in the volume of filtrate at <2 min indicates a deposition of filter cake. Once the filter cake was formed, the amount of fluid traversing the disc dropped significantly. With a submicron PLA particle dispersion as the filtration control agent (L2 and L3), the filter cake formed more quickly and had reduced permeability, resulting in an almost 50% decrease in the filtrate volume using PLA dispersion in the drilling fluid compared with starch.

A cleanup experiment was then performed to demonstrate complete removal of the filter cake. The filter press was removed from the stand and soaked in a 10% acetic acid at 66° C. (150° F.) for one hour. After rinsing, the press was reassembled, and unrestricted flow was observed (data not shown), indicating complete removal of the filter cake.

### Example 1

The above filtration experiments will be repeated with a drilling fluid, and a drill-in fluid. Results will be comparable, as the presence of clay or weighting agents is not expected to significantly change the chemistry or permeability properties of the filter cake.

### Example 2

Experiments can also be conducted to study the effect of temperature on the stability and filtration properties of the PLA in drilling fluid. PLA can be used up to the deformation temperature of the PLA particles and to some degree above the deformation temperature. Significantly above this temperature, however, feasibility is expected to drop as the particles melt or otherwise degrade. Table 3 below provides predicted permeability of filter cake at varying reservoir conditions.

TABLE 3
Effect of temperature on filtration property
of drilling/completion fluid.

| | Predicted permeability of filtration cake |
|---|---|
| Temperature (° F) | formed by fluid containing PLA |
| 100 | Impermeable |
| 180 | Impermeable |
| 250 | Permeable |

### Example 3

The above filtration experiments may be repeated with the various forms of PLA at a variety of temperatures. Results will be comparable, although temperature optima are expected to differ for the differing forms. Thus, we anticipate that higher melting PLA variants will be useful at higher temperatures, although cleanup may require more time and/or a higher concentration of weak acid.

### Example 4

Further filtration experiments with varying concentrations of PLA in drilling and completion fluid may be conducted as described above to assess the effect of concentration of the PLA. Increased amounts of PLA in the drilling fluid may provide less permeable filter cakes, but at some point, the dissolution of the highly impermeable filter cake may be more difficult. Hence an optimization experiment may be conducted as described above to provide an optimum balance of permeability and ease of clean-up.

### Example 5

Experiments can also be conducted to study the effect of the average molecular weight (MW) of the PLA on the stability and filtration properties of the PLA in drilling fluid. Experiments are performed as described above but testing differing MW PLA samples. Higher MW PLA will provide decreased permeability, but at some point, it may become harder to remove. This result may vary however with the temperature of the reservoir.

The examples herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

The following references are incorporated by reference in their entirety for all purposes:
U.S. Pat. No. 4,021,355 Compositions for fracturing well formations.
CA2326714 New and improved drilling fluids and additive therefor.
JABER, A. J. et al. “The role of drilled formation in filter cake properties utilizing different weighting materials,” ACS Omega 6:24039-24050 (2021).
KELESSIDID, V. C. et al. “Permeability, porosity and surface characteristics of filter cakes from water-bentonite suspensions,” WIT Transactions on Engineering Sciences, Vol. 56, 173-182 (2007).
SORRENTINO, G. et al., “Improved filtration parameters from modified API filter press,” Geoenergy Science & Engineering 224:211605 (2023),
YOSHIMURA, K., et al., “Development of polyglycolic- and polylactic-acid fluid-loss-control materials for fracturing fluids,” SPE Drill & Compl. 30 (4): 295-309 SPE-168179-PA (2015).
NAKAI, T. et al. “Development of a new completion fluid using polyglycolic acid powder.” SPE-134385-MS (2010)
MADKAOUR, T. et al., “High performance nature of biodegradable polymeric nanocomposites for oil-well drilling fluids,” Egyptian Journal of Petroleum 25 (2): 281-291 (2016).
API RP 13B-1-Recommended practice for field testing water-based drilling fluids
ISO 10414-1:2008 Petroleum and natural gas industries—Field testing of drilling fluids—Part 1: Water-based fluids.

1. A drilling fluid for drilling a well in a hydrocarbon reservoir comprising:
a) an aqueous carrier fluid;
b) a viscosity increasing agent selected from a clay, a polysaccharide, a polymer and combinations thereof;
d) a bridging agent; and
e) a solid poly(lactic acid) filtration control agent.

2. The drilling fluid of claim 1 comprising a weighting agent.

3. The drilling fluid of claim 1 further comprising one or more additives.

4. The fluid of claim 1, wherein the poly(lactic acid) is in the form of solid submicron particles dispersed in said aqueous carrier fluid.

5. The fluid of claim 1, wherein the poly(lactic acid) is poly-DL-lactide.

6. The fluid of claim 1, wherein concentration of said poly(lactic acid) is about 1-50 lbs/bbl.

7. The fluid of claim 1, wherein the viscosity agent is one or more selected from the group consisting of mud, clay, bentonite clay, cellulose, guar gum, carboxymethylcellulose, xanthum gum, modified xanthum or guar gum derivatives selected from a group consisting of xanthum or guar gum grafted with acrylic acid, acrylamide, and 2-acrylamido-2-methylpropane sulfonic acid.

8. The fluid of claim 1, wherein the viscosity agent is a xanthum gum at about 0.1 to 50 lbs/bbl.

9. The fluid of claim 1, wherein the bridging agent is one or more selected from the group consisting of calcium carbonate, magnesium oxide, suspended salt (water-soluble) and oil-soluble resins.

10. The fluid of claim 1, wherein the bridging agent is calcium carbonate at about 10-50 lbs/bbl.

11. The fluid of claim 1, wherein the weighting agent is one or more selected from the group consisting of barite, calcium carbonite, siderite, micromax, ilmenite, and hematite particles.

12. The fluid of claim 3 wherein the one or more additives is selected from the group consisting of salts, pH control additives, surfactants, breakers, biocides, crosslinkers, additional fluid loss control agents, stabilizers, chelating agents, scale inhibitors, gases, mutual solvents, particulates, corrosion inhibitors, oxidizers, reducers, friction reducers, drilling lubricant, acid precursors, enzymes, clay stabilizers, and combinations thereof.

13. The fluid of claim 1, the aqueous carrier fluid being a brine.

14. A method of drilling in a hydrocarbon formation, said method comprising:
a) drilling a borehole in a hydrocarbon formation using the drilling fluid of claim 1 to form a filter cake on a wall of said borehole;
b) continuing step a) until drilling is complete; and
c) removing said filter cake with a cleaning fluid comprising a weak acid.

15. The method of claim 14, wherein the weak acid is acetic acid.

16. The method of claim 14, wherein the reservoir is at a temperature of less than 100° C.
